(19) United States
(12) Patent Application Publication
(10) Pub. No.: US 2008/0135024 A1
(43) Pub. Date: Jun. 12, 2008

(54) Internal combusting engine

(76) Inventor: Sergei Latyshev, Jerusalem (IL)

Correspondence Address: SERGEI LATYSHEV, YASMIN ALLEY 2/6, JERUSALEM, 93750, omitted

(21) Appl. No.: 11/987,025

(22) Filed: Nov. 27, 2007

Related U.S. Application Data
(63) Continuation of application No. 10/140,983, filed on May 9, 2002, now Pat. No. 6,793,471.

(51) Int. Cl. F02B 75/24; F02B 33/00

(52) U.S. Cl. 123/50 R; 123/559.1

(57) ABSTRACT

The offered internal combustion engine may be characterized by two mobile opposite cylinders fixed rigidly to each other. Said cylinders move simultaneously in the same direction. The motions of said cylinders are being transferred via connecting rod and hinges to the rotational movements of the crankshaft. Inside the opposite cylinders there are two immovable opposite pistons rigidly fixed to each other and rigidly secured to the housing of the engine. There are two working cavities of shifting volume between the corresponding opposite pistons and opposite cylinders. The inlet and exhaust valves with inlet and exhaust manifolds, injectors with fuel pipes, spark-plugs with high voltage wires are placed on the said pistons. The compressor rigidly connected with the engine housing and through the air inlet manifold supplies air under high pressure to the working cavities of the engine. During the operation of the engine the inlet and exhaust valves take part into providing the compression stroke and working stroke, when both valves are closed. When both valves are open (during the inlet and exhaust strokes) the blowing and cooling of the working cavity of the engine by air under high pressure from the compressor takes place. At the period of time between closing exhaust valve at the end of inlet stroke and closing inlet valve at the beginning of compression stroke compressor supercharging of the working cavity of the engine takes place.

### BACKGROUND OF THE INVENTION

1. Field of the Invention

The present invention relates and can be used as an internal combusting engine.

2. Description of the Related Art

There are various designs of internal combusting engine in which the reciprocating movement is carried out by opposite cylinders:

WO00/77366A1 in which two mobile cylinders are fixed to each other in the area of the central transverse section and carry out reciprocating movements relative to stationary pistons fixed to opposite sections of the housing. The heads of the said pistons are directed towards each other. Working cavities between corresponding pistons and cylinders are interconnected through transfer ports and conduits which are situated in the mobile cylinder.

U.S. Pat. No. 6,032,622 in which dual (opposite) mobile cylinders are mounted on an elongated shaft cam (pin). The shaft cam (pin) is situated between transverse cylinders parts. The said cylinders carry out a reciprocating movement relative to the stationary pistons fixed to the opposite parts of the housing. The heads of the said pistons are directed towards each other.

There are also “Fluid machine” (See U.S. Pat. No. 6,793,471 B2, Israel Pat. No 128763) in which two mobile opposite cylinders fixed rigidly to each other. Transverse closed pats of said cylinders are situated on their outside ends. Said cylinders carry out reciprocating movements which always occur simultaneously in the same direction. Inside the opposite cylinders there are two stationary opposite pistons are fixed to each other and rigidly secured to the housing. The offered invention is a continuation and addition to the said invention “Fluid machine” and represents a way of its application as an “Internal combustion engine”.

### SUMMARY OF THE INVENTION

The present internal combusting engine comprise a housing. The crankshaft is secured to the seats of the housing through bearings and is connected through a crank hinge, the connecting rod and the axial hinge with the mobile opposite cylinders. Two mobile opposite cylinders are fixed rigidly to each other. Transfers closed parts of said cylinders are situated on their outside ends. Said cylinders carrying out reciprocating movements which occur always simultaneously in the same direction. Two stationary opposite pistons are fixed to each other in the area of their skirts and from there rods, passing through the holes in the walls of the opposite cylinders outside the limits of working cavities, are rigidly secured to said housing. The heads of said pistons are directed outside from each other. The inlet and exhaust valves with inlet and exhaust manifolds, injectors with fuel pipes, spark-plugs with high voltage wires are placed on the said pistons. Two non-interconnected working cavities are situated between the corresponding piston and cylinder. The air inlet manifolds, laid inside the said opposite pistons are joining the working cavity of the compressor with said working cavities of the engine. The engine exhaust manifolds, laid inside the said opposite pistons are joining the working cavities of the engine with the exhaust pipe. The compressor is rigidly connected to the engine housing and through the transmission gears gets rotational movements from said engine crankshaft. The said compressor has an air inlet pipe with an air filter designed to supply clean ambient air to the working cavity of the compressor. Said compressor under high pressure is supplying air through the said air inlet manifolds to the said working cavities of the engine. The said inlet and exhaust valves are set into motion by means of camshaft cams of a gas distribution system and are designed both for gas distribution, compressor supercharging in the engine's operation and for cooling of walls of the said working cavities of the engine and engine exhaust manifolds by blowing air under high pressure from said compressor. While the engine operates, during the working stroke both valves are closed. At the end of the working stroke the exhaust valve opens. Hot gases start leaving the working cavity through the engine exhaust manifolds. At the beginning of the next exhaust stroke the inlet valve opens. From the air inlet manifold cold air from the compressor starts blowing the working cavity under high pressure. Both valves remain open during the exhaust stroke and the following inlet stroke. At this time the blowing and cooling working cavity and the engine exhaust manifold with high-pressure cold air continues. At the end of the inlet stroke the exhaust valve closes. The air blowing of the working cavity is over. The clean air under pressure fills the working cavity through the air inlet manifold and open inlet valve. At the beginning of the following compression stroke inlet valve closes. At the period of time between closing the exhaust valve at the end of the inlet stroke and closing the inlet valve at the beginning of the compression stroke is performing a function of compressor supercharging. At the end of the compression stroke the fuel mixture is injected into the working cavity through an injector and at once the fuel mixture is ignited by an electric spark from the spark-plug. The working stroke begins and the whole process repeats itself. At the same time whole said process take place also in the other working cavity of engine.

### BRIEF DESCRIPTION OF THE DRAWINGS

FIG. 1 is a sectional view of the present internal combusting engine made in keeping with the present invention;

FIG. 2 is a sectional view of the present internal combusting engine showing the back mobile cylinder, stationary piston with the valves and manifolds in during of operation at the beginning of the working stroke;

FIG. 3 is a view of FIG. 2 at the end of the working stroke;

FIG. 4 is a view of FIG. 2 at the beginning of the exhaust stroke;

FIG. 5 is a view of FIG. 2 at the beginning of the inlet stroke;

FIG. 6 is a view of FIG. 2 at the end of the inlet stroke;

FIG. 7 is a view of FIG. 2 at the beginning of the compression stroke;

### DETAILED DESCRIPTION OF THE PREFERRED EMBODIMENTS

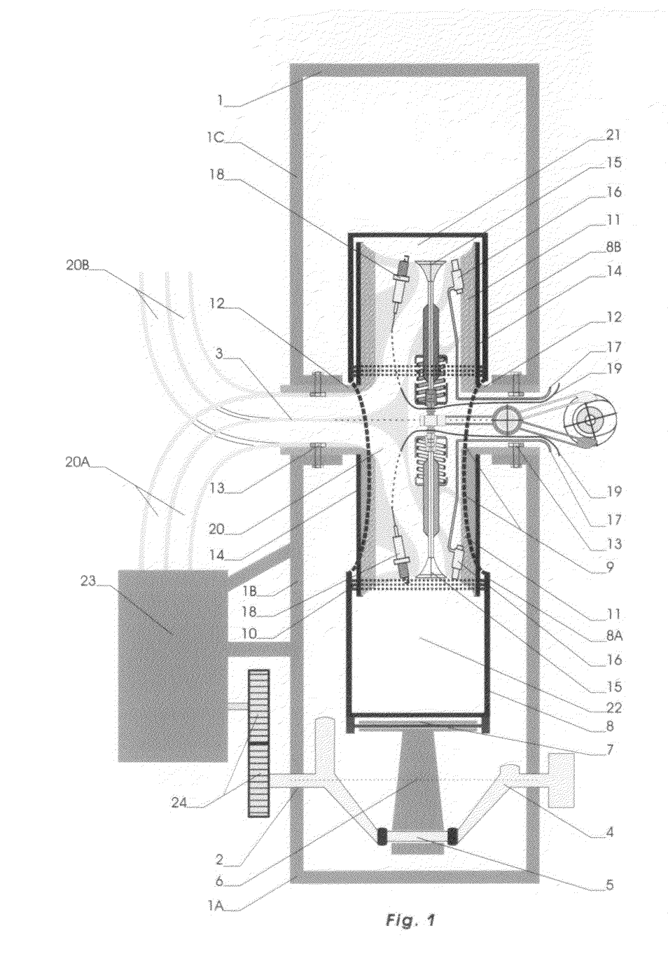

The present internal combustion engine comprises (see FIG. 1) a housing 1. The housing of the engine of the present design consist of three parts—back 1A, middle 1B and front 1C. Between parts of the housing there are gaskets (not shown). The parts of the housing are fixed with screws and bolts (not shown). Between the back part 1A and the middle part 1B on both sides of the housing there are seats 2 for crankshaft bearings. Between the middle part 1B and the front part 1C on both sides of the housing there are round-shaped recesses 3 with holes in the middle.

The crankshaft 4 is secured to the seats 2 of the housing through bearings (not shown). The crankshaft is connected through a crank hinge 5, the connecting rod 6 and an axial hinge 7 with the mobile cylinder body 8.

The cylinder body 8 with the opposite cylinders 8A, 8B entering it and made of light metal alloys. Said cylinders are rigidly fixed to each other. Transverse closed parts of said cylinders are situated on their outside ends. On its both sides in the middle part there are oval holes 9. On the inside in the back and front parts there are channel-shaped recesses in the wall that serve for fixing two types of rings 10 (compression and oil-control rings). Inside the opposite cylinders 8A, 8B of the cylinder body 8 there are two stationary opposite pistons 11, which are fixed to each other in the area of their skirts and from there rods 12 passing through holes 9 in the walls of opposite cylinders, are rigidly secured to said housing 1 with screws and bolts 13 in the recess area 3 of the engine housing. The heads of said pistons are directed outside of each other. Side piston surfaces are working sliding surfaces 14 and made of high-strength steel. Each said piston is made with an inlet valve 15A and an exhaust valve 15B which are set into motion by means of camshaft cams of a gas distribution system. The injectors 16 are placed on the said heads of opposite pistons with fuel pipes 17, located inside the opposite pistons and exiting out of the engine through the hole in the recess area 3 of the engine housing 1. The spark-plugs 18 are placed on the said heads of the opposite pistons with high voltage wires 19, located inside of the opposite pistons and are exiting out of the engine through the hole in the recess area 3 of the engine housing 1. Inside the pistons the air inlet manifolds 20A are laid from the inlet valves 15A are exiting out of the engine through the hole in the recess area 3 of the engine housing 1 and are connected with the working cavity of the compressor. Inside the pistons the engine exhaust manifolds 20B are laid from the exhaust valves 15B and are exiting out of the engine through the hole in the recess area 3 of the engine housing 1 and are connected with the exhaust pipe of the engine. The cavities between the corresponding opposite pistons 11 and the internal surface of the opposite cylinders 8A, 8B of the cylinder body 8 represent non-interconnected working cavities. In the present design there are two working cavities—front 21 and back 22. A compressor 23 rigidly connected to the engine housing 1 and through transmission gears 24 receives rotational movement from said engine crankshaft 4. Said compressor 23 there is an air inlet pipe (not shown) with air filter (not shown) designed to supply clean ambient air to working cavity of compressor (not shown). Said working cavity of compressor through said an air inlet manifolds 20A and holes with an inlet valves 15A connected with the front 21 and back 22 working cavities of engine.

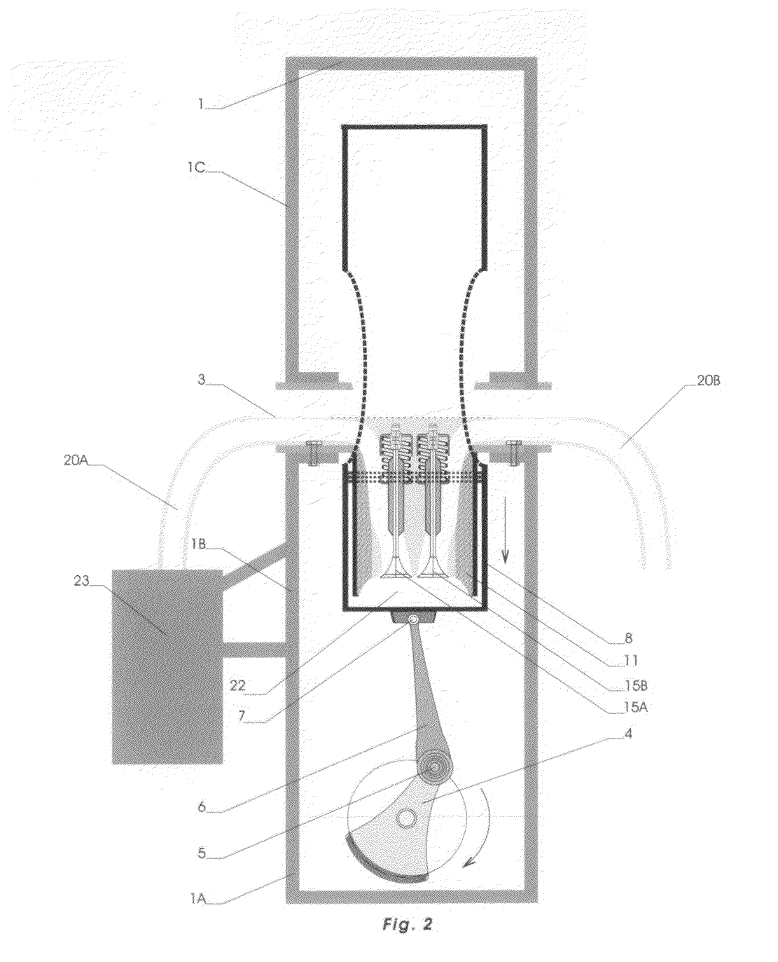

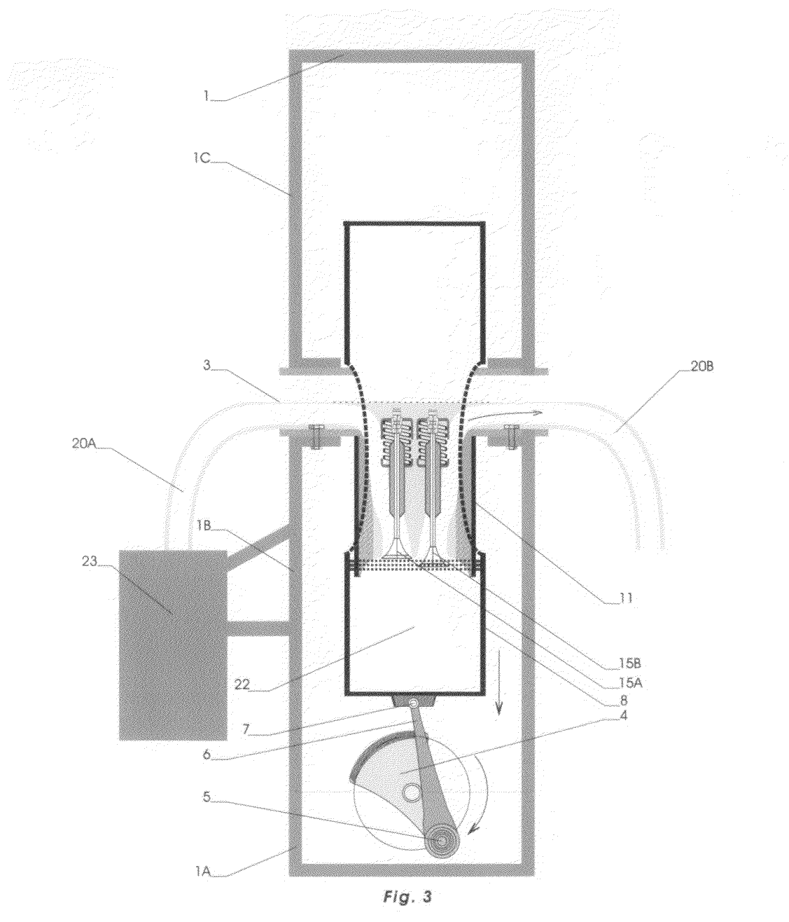

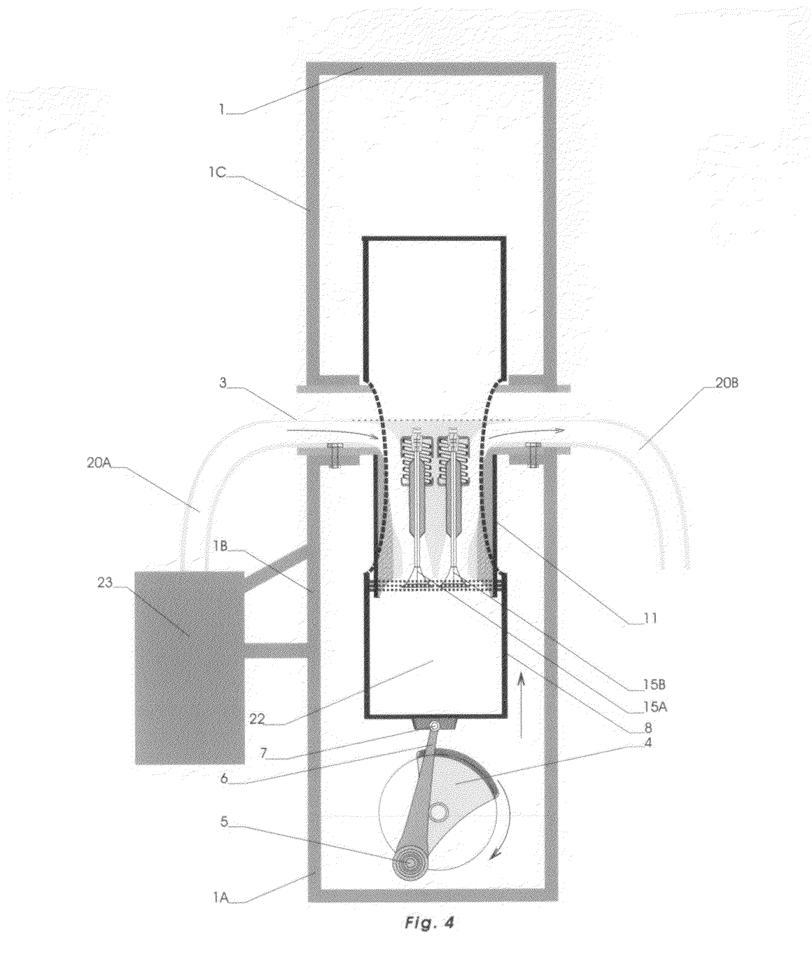

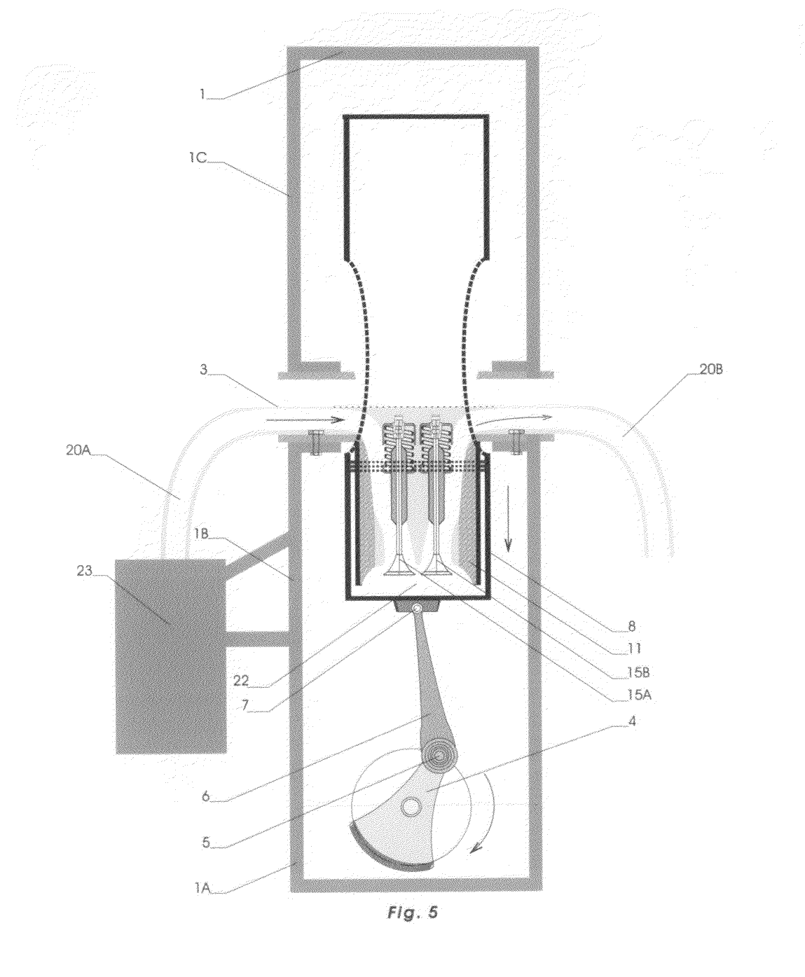

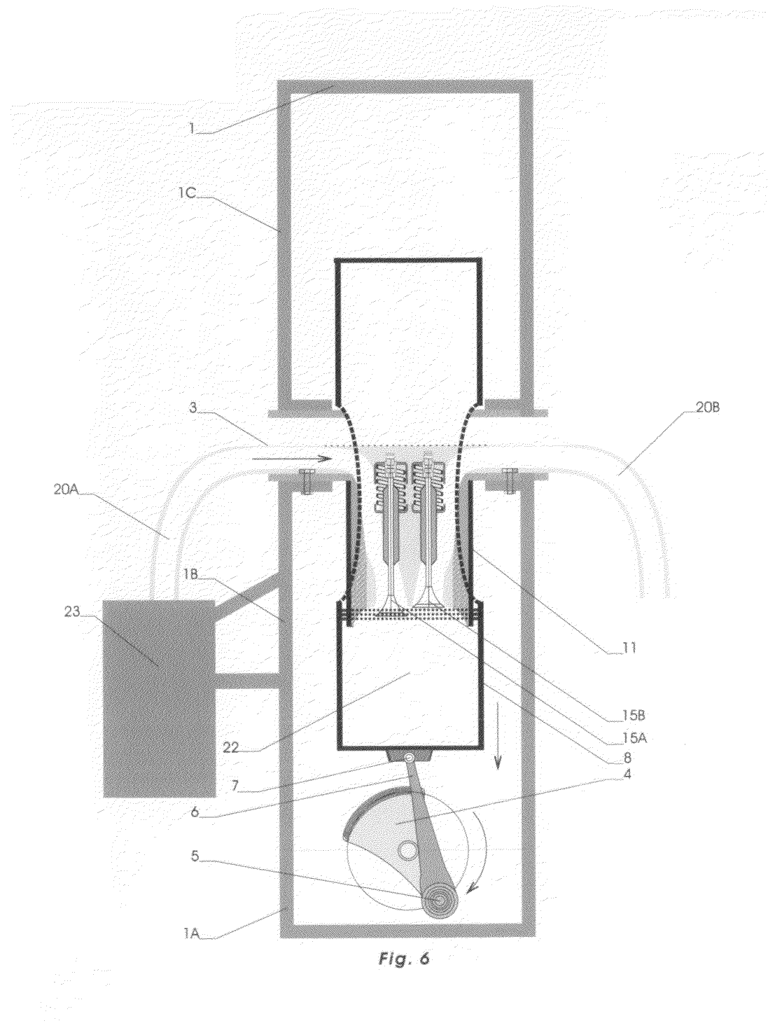

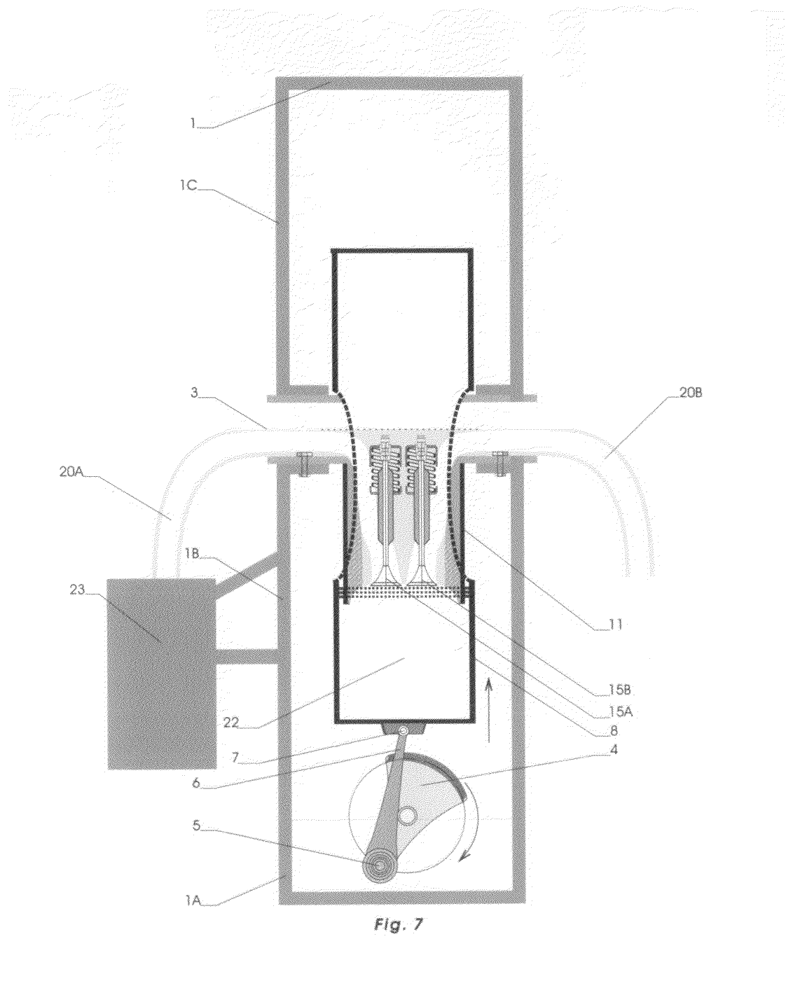

Principle of operation of the present internal combusting engine. While the engine operates the compressor 23 is set into motion through transmission gear 24 from the crankshaft 4 of the engine. Through the air inlet pipe and air filter the ambient air enters the compressor working cavity and afterwards is boosted under high pressure into air inlet manifolds 20A leading to front 21 and back 22 working cavities of the engine. During the explosion of the gas mixture in the back working cavity of the engine and the working stroke (see FIG. 2) the inlet valve 15A and exhaust valve 15B are closed. Under the action of hot gas pressure the mobile cylinder 8 starts moving downwards from the fixed piston 11. At this time the walls of the back working cavity 22 are heated with hot gases. At the end of the working stroke (FIG. 3) the exhaust valve 15B opens. Hot gases start leaving the back working cavity 22 and combine with the ambient air through the engine exhaust manifold 20B. Gas pressure in the back working cavity 22 drops. At the beginning of the next exhaust stroke (see FIG. 4) when the mobile cylinder 8 starts moving in the opposite direction (upwards) the inlet valve 15A opens. From the air inlet manifold 20A cold air from the compressor 23 starts blowing the back working cavity 22 under high pressure. At this time both valves 15A, 15B are open. Cold air cools the walls of the back working cavity 22 and leaves through engine exhaust manifold 20B cooling its walls as well. Both inlet 15A and exhaust 15B valves remain open and the back working cavity 22 and engine exhaust manifold 20B blowing with high pressure cold air continues while the mobile cylinder 8 is in the upper position. During the next inlet stroke (see FIG. 5) when the mobile cylinder 8 moves downwards both valves 15A, 15B remain open. The blowing of walls of the back working cavity 22 and engine exhaust manifold 20B with high-pressure cold air continues. At the end of this stroke (see FIG. 6) when the mobile cylinder 8 moves downwards the exhaust valve 15B closes. Air blowing of the back working cavity is over. Clean air under pressure fills the back working cavity 22 through the air inlet manifold 20A and the open inlet valve 15A. At this time compressor supercharging of the back working cavity of the engine occurs. At the beginning of the following stroke (see FIG. 7) when the mobile cylinder 8 starts moving upwards the inlet valve 15A closes. Now both the inlet 15A and exhaust 15B valves are closed. The mobile cylinder 8 continues its movement upwards accomplishing the compression stroke. At the end of the compression stroke the fuel mixture is injected into the back working cavity 22 through a fuel pipe 17 and an injector 16 and at once the fuel mixture is ignited by an electric spark from the spark-plug 18. Pressure and temperature in the back working cavity rise sharply. The mobile cylinder 8 is moving downwards and the working stroke begins. The whole process repeats itself. While in operation of the engine all the said processes occurring in the back working cavity take place also in the front working cavity of the engine.

Thus, when present internal combusting engine operates, during working stroke the walls of the working cavity are heated with hot gases and during exhaust stroke and inlet stroke or about 50% of the time, the walls of engine working cavities and exhaust manifolds are cooled (by blowing with air under pressure). Since the compressor is connected with the engine crankshaft through a transmission gear, the blowing and cooling of walls of the engine working cavities and exhaust manifolds with air under pressure increases with engine revolutions.

In present internal combusting engine during one full rotation of the crankshaft four strokes of the engine take place (two in the front and two in the back working cavities of the engine).

The offered engine is also more ecologically clean than the internal combustion engines that are being used at the present time. This is being achieved because during the exhaust stroke an air blowing of the engine under high pressure takes place. The compound of unburned (suboxided) particles of fuel hydrocarbons that had remained after the working stroke with the air oxygen and its delayed burning (oxidation) takes place. As a result of this the exhaust gases of the engine shall contain a lot less hazardous emissions polluting the environment.

What is claimed is:

1. Internal combusting engine comprising:
a housing;
a crankshaft is secured to the seats of the housing through the bearings and designed for rotational movements and for taking out of the engine useful rotational efforts;
two mobile opposite cylinders fixed rigidly to each other;
two stationary opposite pistons are fixed to each other in the area of their skirts and from there rods, passing through holes in the walls of opposite cylinders outside the limits of working cavities are rigidly secured to said housing;
the heads of said pistons are directed outside from each other and made with an inlet valve and exhaust valve;
an air inlet manifolds, which is lied inside the said opposite pistons and designed for entry of fresh air into working cavities of the engine;
an engine exhaust manifolds, which is lied inside the said opposite pistons and designed for the removal of exhaust gases from the working cavities of the engine;
an injectors are placed on the heads of the opposite pistons with pipes located inside the opposite pistons and are designed for the supply of fuel mixture to working cavities of the engine;
the spark-plugs are placed on the heads of the opposite pistons with high voltage wires located inside of the opposite pistons and are designed for ignition of the fuel mixture in the working cavities of the engine;
two non-interconnected working cavities are situated between corresponding piston and cylinder;
a compressor rigidly connected to said housing and designed for the supply of air under high pressure through the said air inlet manifolds into the said working cavities of the engine;
said an inlet valves and discharge valves are set into motion by means of camshaft cams of a gas distribution system designed both for gas distribution, compressor supercharging in the engine operation and for cooling of walls of said working cavities and exhaust manifolds by blowing air under high pressure from said compressor.

2. An internal combustion engine of claim 1, wherein said crankshaft is connected through a crank hinge, the connecting rod and an axial hinge with the mobile opposite cylinders.

3. An internal combustion engine of claim 1, wherein said crankshaft is connected through the transmission gears with the compressor.

4. An internal combusting engine of claim 1, wherein transverse closed parts of said cylinders are situated on their outside ends.

5. An internal combusting engine of claim 1, wherein said cylinders carrying out reciprocating movement which occur always simultaneously in the same direction.

6. An internal combusting engine of claim 1, wherein said inlet manifolds is connected working cavity of compressor with said working cavities of engine through holes with inlet valves.

7. An internal combusting engine of claim 1, wherein said exhaust manifolds is connected working cavities of engine through holes with exhaust valves with exhaust pipe of engine.

8. An internal combusting engine of claim 1, wherein said compressor through transmission gear receives rotational movement from said engine crankshaft.

9. An internal combusting engine of claim 1, wherein said compressor there is an air inlet pipe with air filter designed to supply clean ambient air to working cavity of compressor.

10. An internal combusting engine of claim 1, wherein said inlet and exhaust valves at the operation of the engine take part in the implementation of the compression stroke and the working stroke, when both valves are closed.

11. An internal combusting engine of claim 1, wherein said inlet and exhaust valves at the operation of the engine take part in its cooling both during the exhaust stroke and the inlet stroke, when both valves are open and blowing the walls of the working cavities and engine exhaust manifolds with air under high pressure from said compressor takes place.

12. An internal combusting engine of claim 1, wherein said inlet and discharge valves at the operation of the engine take part the implementing its compressor supercharging function at the period of time between closing exhaust valve at the end of inlet stroke and closing inlet valve at the beginning of compression stroke.
